(19) United States
(12) Patent Application Publication
(10) Pub. No.: US 2019/0129412 A1
(43) Pub. Date: May 2, 2019

(54) PARKING-SPACE-EXIT ASSIST SYSTEM

(71) Applicant: MANDO CORPORATION, Pyeongtaek-si (KR)

(72) Inventor: Tak Gen KIM, Seongnam-si (KR)

(73) Assignee: MANDO CORPORATION

(21) Appl. No.: 16/172,151

(22) Filed: Oct. 26, 2018

(30) Foreign Application Priority Data
Oct. 27, 2017 (KR) 10-2017-0140991

(51) Int. Cl. G05D 1/00; G05D 1/02

(52) U.S. Cl. CPC G05D 1/0016; G05D 2201/0213; G05D 1/021; G05D 1/0044

(57) ABSTRACT

Disclosed herein is a parking-space-exit assist system. The system of the present invention includes a driver device owned by a driver, and an assist device provided in a vehicle and configured to cause the vehicle to exit a parking space when it is determined that the driver device is within a prescribed distance from the vehicle or is expected to arrive at the vehicle within a prescribed amount of time.

### CROSS-REFERENCE TO RELATED APPLICATION

Pursuant to 35 U.S.C. § 119 (a), this application claims the benefit of earlier filing date and right of priority to Korean Patent Application No. 10-2017-0140991, filed on Oct. 27, 2017, the contents of which are hereby incorporated by reference in their entirety.

### BACKGROUND

### 1. Field of the Invention

The present invention relates to a parking-space-exit assist system.

### 2. Discussion of Related Art

Vehicles have become a necessity for modern people. With an increase in the number of vehicles, various social problems such as traffic congestion and parking problems have been caused.

In particular, in some areas such as large cities, parking spaces are inevitably reduced as the number of vehicles increases. To overcome the shortage of parking space, a parking space partitioned for parking one vehicle has become narrower and narrower.

Accordingly, since a gap between parked vehicles is inevitably narrow, it is difficult for a driver to park a vehicle in a parking space or exit the parking space. In particular, it is very difficult for an inexperienced driver to park in or exit a narrow parking space.

Meanwhile, with the rapid development of automobile technologies, technologies related to various convenience devices for driver's convenience have been developed steadily. A parking-space-exit assist system for assisting a driver in safely driving a parked vehicle out of a parking space as well as a parking assist system for assisting a driver in parking have been developed.

Particularly, in recent years, there has been developed a parking-space-exit assist system capable of causing a vehicle to exit a parking space even when a driver is not in the vehicle.

### SUMMARY OF THE INVENTION

The present invention is directed to providing a parking-space-exit assist system and control method thereof capable of causing a vehicle to automatically exit a parking space before a driver approaches the vehicle, thereby promoting user convenience.

To achieve the above object, a parking-space-exit assist system according to an embodiment of the present invention includes a driver device owned by a driver, and an assist device provided in a vehicle and configured to cause the vehicle to exit a parking space when it is determined that the driver device is within a prescribed distance from the vehicle or is expected to arrive at the vehicle within a prescribed amount of time.

According to an embodiment of the present invention, the assist device may include a first determiner configured to determine a distance between the driver device and the vehicle, and a first controller configured to generate a control signal for causing the vehicle to exit the parking space when the distance between the driver device and the vehicle is within the prescribed distance.

According to an embodiment of the present invention, the assist device may further include a first generator configured to generate a parking-space-exit path of the vehicle, and the first controller may generate a control signal so that the vehicle exits the parking space according to the parking-space-exit path generated in the first generator.

According to an embodiment of the present invention, the first generator may generate the parking-space-exit path of the vehicle in consideration of a parking-space-exit direction selected by the driver and a parking-space-exit direction.

According to an embodiment of the present invention, the assist device may further include a second determiner configured to determine time taken for the driver device to reach the vehicle, and the first controller may generate a control signal for causing the vehicle to exit the parking space when the distance between the driver device and the vehicle is within the prescribed distance and/or when the time is a prescribed amount of time or less.

According to an embodiment of the present invention, the assist device may further include a second generator configured to generate a parking-space-exit path of the vehicle, and the first controller may generate a control signal so that the vehicle exits the parking space according to the parking-space-exit path generated in the second generator.

According to an embodiment of the present invention, the second generator may generate the parking-space-exit path of the vehicle in consideration of a parking-space-exit direction selected by the driver and a parking-space-exit direction.

According to an embodiment of the present invention, the driver device may include a display unit, a second controller configured to control a parking-space-exit application, and a third controller configured to control operation of the driver device on the basis of a driver's selection received via the parking-space-exit application and information received from the assist device.

According to an embodiment of the present invention, the second controller may receive a selection on a parking-space-exit period of the vehicle and a selection on a parking-space-exit direction of the vehicle via the display unit and provide the selections to the third controller.

According to an embodiment of the present invention, the driver device may further include a first module configured to receive position information of the driver device, and the first determiner may determine the distance between the driver device and the vehicle by using position information of the vehicle provided from a second module configured to receive the position information of the vehicle and by using the position information of the driver device.

According to an embodiment of the present invention, the driver device may include a button configured to receive a parking-space-exit assist selection from the driver, an alarm unit configured to notify the driver of the fact that it is possible to cause the vehicle to exit the parking space, and a fourth controller configured to transmit the driver's parking-space-exit selection information to the assist device when the driver provides a signal to the button.

According to an embodiment of the present invention, the assist device may further include a signal requester configured to generate a position request signal that requests for the position information of the driver device, the driver device may further include a signal generator configured to generate a position signal related to the position request signal, wherein the first determiner may determine the distance between the driver device and the vehicle by using speeds of the position request signal and the position signal and a time difference between time at which the position request signal is transmitted and time at which the position signal is received.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram for describing an operation of a parking-space-exit assist system according to an embodiment of the present invention;

FIG. 2 is a block diagram of the parking-space-exit assist system according to an embodiment of the present invention;

FIG. 3 is an exemplary diagram of a parking-space-exit application displayed on a driver device;

FIG. 4 is a flowchart showing a process in which remote parking-space-exiting is performed in the parking-space-exit assist system according to an embodiment of the present invention;

FIG. 5 is a conceptual diagram for describing an operation of a parking-space-exit assist system according to another embodiment of the present invention;

FIG. 6 is a block diagram of the parking-space-exit assist system according to the other embodiment of the present invention; and

FIG. 7 is a flowchart showing a process in which remote parking-space-exiting is performed in the parking-space-exit assist system according to the other embodiment of the present invention.

### DETAILED DESCRIPTION OF EXEMPLARY EMBODIMENTS

The invention described hereunder may be applied with various changes and several exemplary embodiments, and particular exemplary embodiments will be described in detail through exemplary drawings and detailed descriptions.

However, it should be noted that the present invention is not limited to particular exemplary embodiments, and it will be appreciated that the present invention described is intended to embrace all such alterations, modifications, and variations that fall within the scope and novel idea of the present invention. Hereinafter, exemplary embodiments of the present invention will be described in detail with reference to the accompanying drawings.

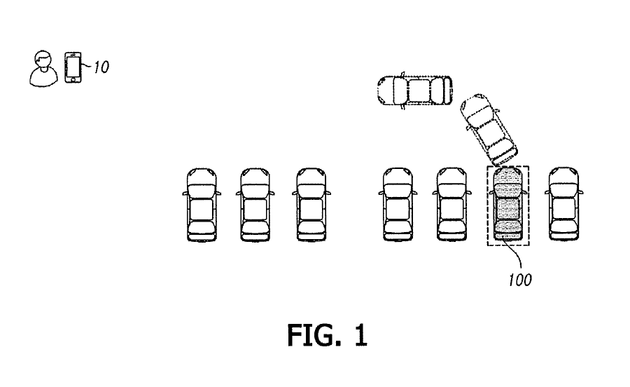

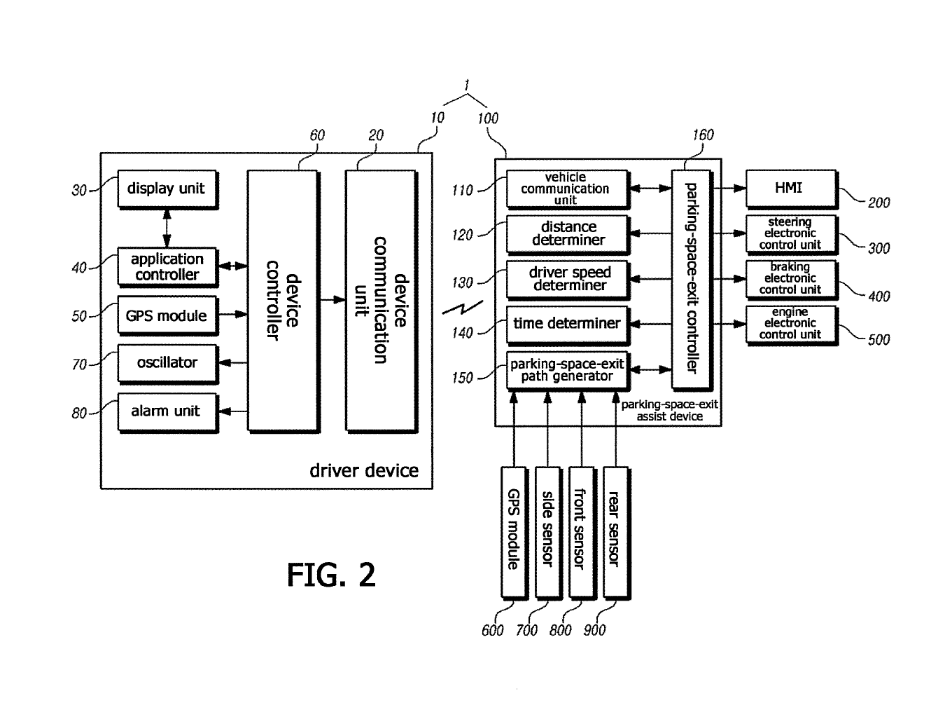

FIG. 1 is a conceptual diagram for describing an operation of a parking-space-exit assist system according to an embodiment of the present invention, and FIG. 2 is a block diagram of the parking-space-exit assist system according to an embodiment of the present invention.

As illustrated in the drawings, a parking-space-exit assist system 1 according to an embodiment of the present invention may include a driver device 10 owned by a driver, and a parking-space-exit assist device 100 provided in a vehicle and configured to communicate with the driver device 10, identify a position of the driver, and cause the vehicle to automatically exit a parking space.

For example, the driver device 10 may be a small communication device such as a mobile phone or a tablet personal computer (PC) or a vehicle smart key owned by the driver.

Referring to FIG. 2, the driver device 10 according to an embodiment of the present invention may include a device communication unit 20 configured to transmit and receive data to and from the vehicle, a display unit 30 configured to display information, a global positioning system (GPS) module 50 configured to receive position information of the driver device 10, an application controller 40 configured to control a parking-space-exit application, a device controller 60 configured to control the driver device 10 in relation to the automatic parking-space-exiting, an oscillator 70 configured to display, using vibration, that the parking-space-exiting is possible, and an alarm unit 80 configured to display, using sound, that the parking-space-exiting is possible.

The driver device 10 according to an embodiment of the present invention may be a small communication device such as a mobile phone or a table PC in which the display unit 30 has already been formed or may be a vehicle smart key in which the display unit 30 is disposed.

The device communication unit 20 assists communication with the vehicle, and when the driver device 10 is a small communication device such as a mobile phone or a tablet PC, the device communication unit 20 may communicate using a mobile communication network. When the driver device 10 is a smart key, the device communication unit 20 may use the mobile communication network or communicate with the vehicle using a radiofrequency (RF) communication method.

The display unit 30 may output information processed in the driver device 10 according to control of the application controller 40. The display unit 30 may include at least one of a liquid crystal display (LCD), a thin film transistor-liquid crystal display (TFT-LCD), an organic light-emitting diode (OLED), and a flexible display.

When the display unit 30 and a sensor configured to detect a touch operation (a touch sensor) form a layered structure with each other (a touchscreen), the display unit 30 may also be used as an input device in addition to being used as an output device.

The GPS module 50 may receive position information of the driver device 10 from a GPS satellite. Such position information may be provided to the device controller 60.

The application controller 40 may display the parking-space-exit application on the display unit 30, or control the parking-space-exit application according to content selected by the driver and store the selected content. The application controller 40 may operate according to control from the device controller 60, display the parking-space-exit application on the display unit 30, and transmit the content selected by the driver via the parking-space-exit application to the device controller 60.

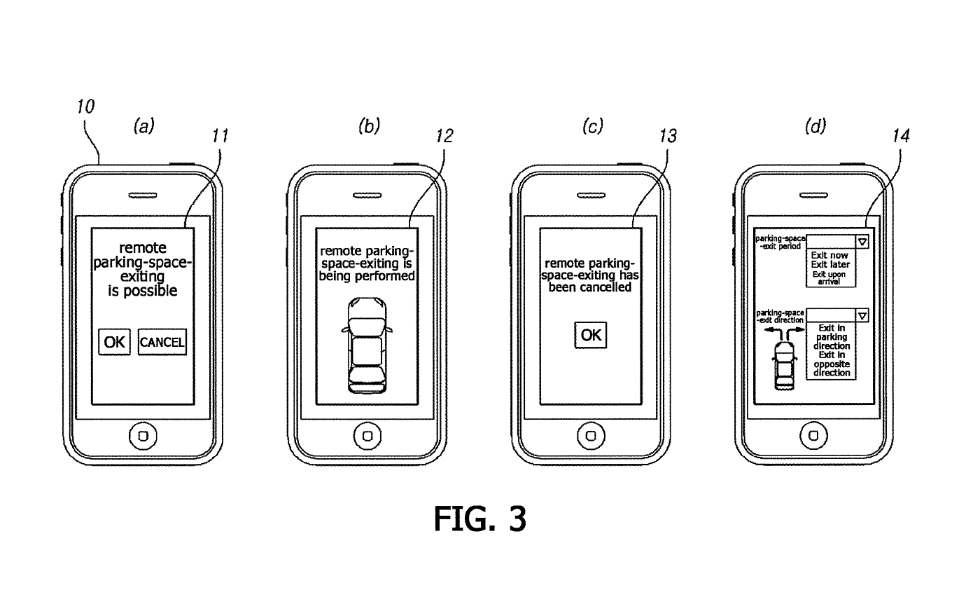

FIG. 3 is an exemplary diagram of the parking-space-exit application displayed on the driver device.

When the parking-space-exit application is activated, as illustrated in (a) of FIG. 3, the application controller 40 may display a message 3A, which indicates that remote parking-space-exiting is possible, on the display unit 30. In this case, in addition to the message 3A which indicates that the remote parking-space-exiting is possible, an OK icon 3B for receiving a driver's selection when the driver wants the remote parking-space-exiting to be performed and a Cancel icon 3C for receiving a driver's selection when the driver does not want the remote parking-space-exiting to be performed may also be displayed.

When the driver selects the OK icon 3B, as illustrated in (b), a message 3D, which indicates that the remote parking-space-exiting is being performed, may be displayed on the display unit 30. On the other hand, when the driver selects the Cancel icon 3C, as illustrated in (c), a message 3E, which indicates that the remote parking-space-exiting has been cancelled, may be displayed on the display unit 30.

Meanwhile, as illustrated in (d), the parking-space-exit application may provide a Settings menu, and the Settings menu may include a window 3F for a selection on a parking-space-exit period and a window 3G for a selection on a parking-space-exit direction.

In the window 3F for the selection on the parking-space-exit period, the driver may select “Exit now,” “Exit later,” “Exit upon arrival,” or the like. The “Exit now” refers to causing the vehicle to exit the parking space immediately when the driver selects the OK icon 3B in the parking-space-exit application; the “Exit later” refers to causing the vehicle to exit the parking space after a certain amount of delay when the driver selects the OK icon 3B; and “Exit upon arrival” refers to causing the vehicle to exit the parking space when the driver device 10 approaches the vehicle within a prescribed distance. In this case, the application controller 40 may also provide a menu for setting the delay time in the “Exit later” and the prescribed distance in the “Exit upon arrival.”

In the window 3G for the selection on the parking-space-exit direction, the driver may select either “Exit in parking direction” or “Exit in opposite direction.” The “Exit in parking direction,” which refers to a case in which the vehicle exits the parking space in a direction in which the vehicle has entered the parking space, may be selected when an exit of the parking space and an entrance of the parking space are in the same direction. The “Exit in opposite direction,” which refers to a case in which the vehicle exits the parking space in a direction opposite from the direction in which the vehicle has entered the parking space, may be selected when the exit of the parking space and the entrance of the parking space are in different directions or when the parking space allows travel in one direction only. When the parking-space-exit direction is not selected by the driver, the “Exit in parking direction,” which is the default setting of the parking-space-exit direction, may be automatically selected.

Meanwhile, a parking-space-exit direction may also be set by selecting a direction of an arrow in a vehicle-shaped icon 3H.

The device controller 60 may communicate with the parking-space-exit assist device 100, which is provided in the vehicle, via the device communication unit 20 and may transmit position information of the driver device 10 detected from the GPS module 50 to the parking-space-exit assist device 100.

The device controller 60 may receive, from the parking-space-exit assist device 100 of the vehicle, information on a distance between the vehicle and the driver device 10 and/or time taken for the driver to arrive at the vehicle. The device controller 60 may notify the driver of the fact that parking-space-exiting is possible when the distance between the vehicle and the driver device 10 reaches a prescribed distance or when the time taken for the driver, who owns the driver device 10, to arrive at the vehicle reaches a prescribed amount of time. Here, the prescribed distance or amount of time may be set as a distance or time at which the exit of the vehicle from the parking space may be completed upon the driver's arrival at the vehicle.

Meanwhile, to notify the driver of the fact that parking-space-exiting is possible, the device controller 60 may operate the application controller 40 and cause the parking-space-exit application to be displayed on the display unit 30. Simultaneously, the device controller 60 may output a message saying “Remote exiting is possible” or generate an alarm sound via a speaker or may operate the oscillator 70 and generate vibration.

The device controller 60 may receive options related to the parking-space-exit period and the parking-space-exit direction set by the driver via the parking-space-exit application from the application controller 40 and may transmit the received information to the parking-space-exit assist device 100 of the vehicle.

Referring back to FIG. 2, the parking-space-exit assist device 100 according to an embodiment of the present invention provided in the vehicle may include a vehicle communication unit 110, a distance determiner 120, a driver speed determiner 130, a time determiner 140, a parking-space-exit path generator 150, and a parking-space-exit controller 160.

Such a parking-space-exit assist device 100 may receive information from a vehicle-side GPS module 600, a side sensor 700, a front sensor 800, and a rear sensor 900 provided in the vehicle and may generate a control signal for control of a human machine interface (HMI) 200, a steering electronic control unit 300, a braking electronic control unit 400, and an engine electronic control unit 500.

The vehicle communication unit 110 may perform communication with the driver device 10 and may perform communication using the mobile communication network or the RF communication method according to a communication method of the driver device 10.

The distance determiner 120 may determine a distance between the driver device 10 and the vehicle, receive current position information of the vehicle from the vehicle-side GPS module 600, receive position information of the driver from the driver device 10 via the vehicle communication unit 110, and determine the distance between the vehicle and the driver. Upon the start of communication with the driver device 10, the distance determiner 120 may determine the distance between the vehicle and the driver at every prescribed time.

The driver speed determiner 130 may receive information on the distance between the vehicle and the driver which is determined in the distance determiner 120 and may determine the speed of the driver by using a time interval at which the distance between the vehicle and the driver is determined in the distance determiner 120 and by using a change in the distance between the vehicle and the driver.

The time determiner 140 may determine the time taken for the driver to arrive at the vehicle by using the speed of the driver determined in the driver speed determiner 130 and the distance between the driver and the vehicle determined in the distance determiner 120.

When parking-space-exiting is selected via the driver device 10, the parking-space-exit path generator 150 may receive information detected from the side sensor 700, the front sensor 800, and the rear sensor 900 and then generate a parking-space-exit path. In this case, the parking-space-exit path generator 150 may generate the parking-space-exit path according to the parking-space-exit direction selected in the driver device 10 and may transmit the generated parking-space-exit path to the parking-space-exit controller 160.

Meanwhile, when the parking-space-exit path generator 150 is unable to generate a parking-space-exit path due to an obstacle or the like, the parking-space-exit path generator 150 may check whether parking-space-exiting is possible in a direction opposite from the selected parking-space-exit direction. When parking-space-exiting is not possible in any of the selected parking-space-exit direction or the opposite direction thereof, the parking-space-exit path generator 150 may transmit a message, which indicates that parking-space-exiting is not possible, to the parking-space-exit controller 160. When parking-space-exiting is possible in the opposite direction of the selected parking-space-exit direction, the parking-space-exit path generator 150 may transmit a parking-space-exit path as well as a message, which indicates that parking-space-exiting is possible in the opposite direction, to the parking-space-exit controller 160.

Upon receiving position information of the driver device 10 through communication with the driver device 10, the parking-space-exit controller 160 operates the distance determiner 120, the driver speed determiner 130, and the time determiner 140 so that the distance between the driver device 10 and the vehicle, the time taken for the driver to arrive at the vehicle, and the like are determined.

When it is determined that the driver is within a prescribed distance from the vehicle or is expected to arrive at the vehicle within a prescribed amount of time, the parking-space-exit controller 160 may operate the parking-space-exit path generator 150 and control the parking-space-exit path generator 150 to generate a parking-space-exit path.

When parking-space-exiting is possible, the parking-space-exit controller 160 may transmit a message, which indicates that parking-space-exiting is possible, to the driver device 10. In addition, the parking-space-exit controller 160 may display a message, which indicates that automatic parking-space-exiting is performed, via the HMI 200 of the vehicle and may generate a control signal for control of the steering electronic control unit 300, the braking electronic control unit 400, and the engine electronic control unit 500 so that the vehicle exits the parking space along the parking-space-exit path.

Meanwhile, when it is determined in the parking-space-exit path generator 150 that parking-space-exiting is possible in the opposite direction of the selected parking-space-exit direction, the parking-space-exit controller 160 may transmit a message, which indicates that parking-space-exiting is possible in the opposite direction of the selected parking-space-exit direction, to the driver device 10.

In addition, the parking-space-exit controller 160 may receive information on a parking-space-exit period from the driver device 10, and when the driver has delayed the parking-space-exit period, the parking-space-exit controller 160 may generate a control signal so that parking-space-exiting starts when a time or distance selected by the driver is reached.

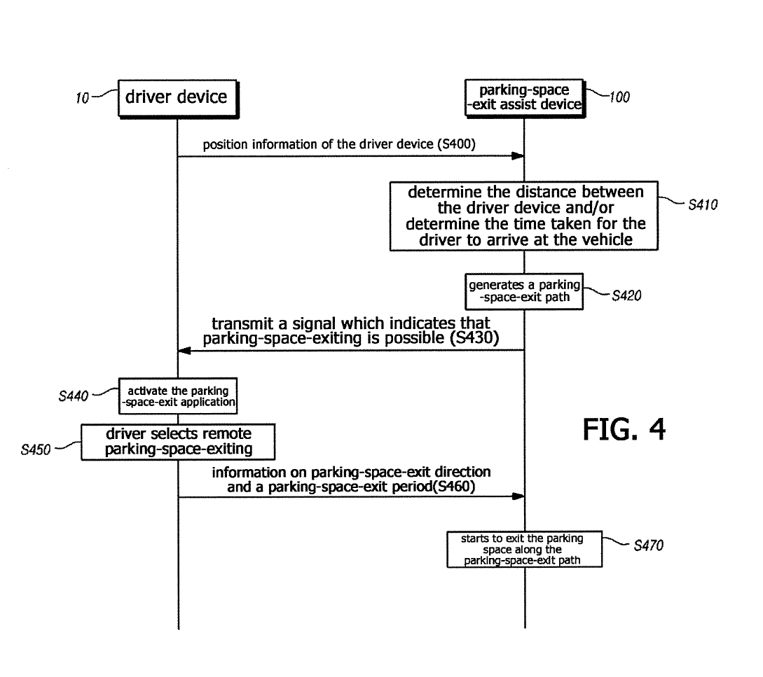

A process in which remote parking-space-exiting is performed in the parking-space-exit assist system 1 according to an embodiment of the present invention according to the above configuration will be described below with reference to FIG. 4.

The parking-space-exit controller 160 of the parking-space-exit assist device 100 may continuously communicate with the driver device 10 using the vehicle communication unit 110 and may receive position information of the driver device 10 from the driver device 10 (S400).

The distance determiner 120 may determine the distance between the driver device 10 and the vehicle by using the position information of the driver device 10 and position information of the vehicle received from the GPS module 600. Then, the driver speed determiner 130 may determine a speed of the driver, and/or the time determiner 140 may determine the time taken for the driver to arrive at the vehicle (S410).

When the distance between the driver device 10 and the vehicle is a prescribed distance or less or the time taken for the drive to arrive at the vehicle is a prescribed amount of time or less, the parking-space-exit controller 160 may control the parking-space-exit path generator 150 so that it determines whether parking-space-exiting is possible and generates a parking-space-exit path in a parking-space-exit direction selected by the driver (S420).

When parking-space-exiting is determined as possible, the parking-space-exit controller 160 may transmit a signal, which indicates that parking-space-exiting is possible, to the driver device 10 (S430). In this case, when a parking-space-exit direction differs from the direction selected by the driver, the parking-space-exit controller 160 may transmit information on the parking-space-exit direction to the driver device 10 (not illustrated).

When the driver device 10 receives the signal, which indicates that parking-space-exiting is possible, from the parking-space-exit assist device 100, the application controller 40 may activate the parking-space-exit application (S440) and, as illustrated in (a) of FIG. 3, may display the message 3A, which says that “remote parking-space-exiting is possible,” on the display unit 30.

When the driver selects remote parking-space-exiting (S450), as illustrated in (b) of FIG. 3, the application controller 40 may display the message 3D, which says that “remote parking-space-exiting is being performed,” on the display unit 30. The application controller 40 may provide, to the device controller 60, information that the driver has selected remote parking-space-exiting and information on a parking-space-exit direction and a parking-space-exit period selected in advance by the driver.

The device controller 60 may transmit information on a selection to perform parking-space-exiting, a parking-space-exit direction, and a parking-space-exit period to the parking-space-exit assist device 100 (S460).

On the other hand, when the driver has not selected remote parking-space-exiting, the device controller 60 may transmit information, which indicates that remote parking-space-exiting has been cancelled by the driver, to the parking-space-exit assist device 100.

Upon confirming that remote parking-space-exiting has been selected, the parking-space-exit controller 160 of the parking-space-exit assist device 100 may display a message, which indicates that automatic parking-space-exiting will be performed, via the HMI 200 in the vehicle and may generate a control signal for control of the steering electronic control unit 300, the braking electronic control unit 400, and the engine electronic control unit 500 so that the vehicle starts to exit the parking space along the parking-space-exit path (S470).

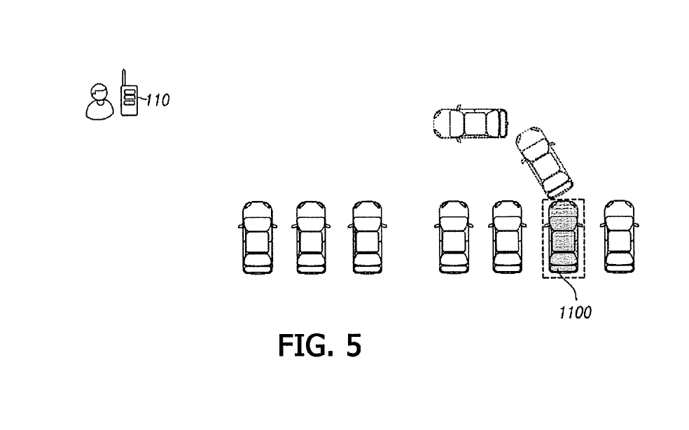

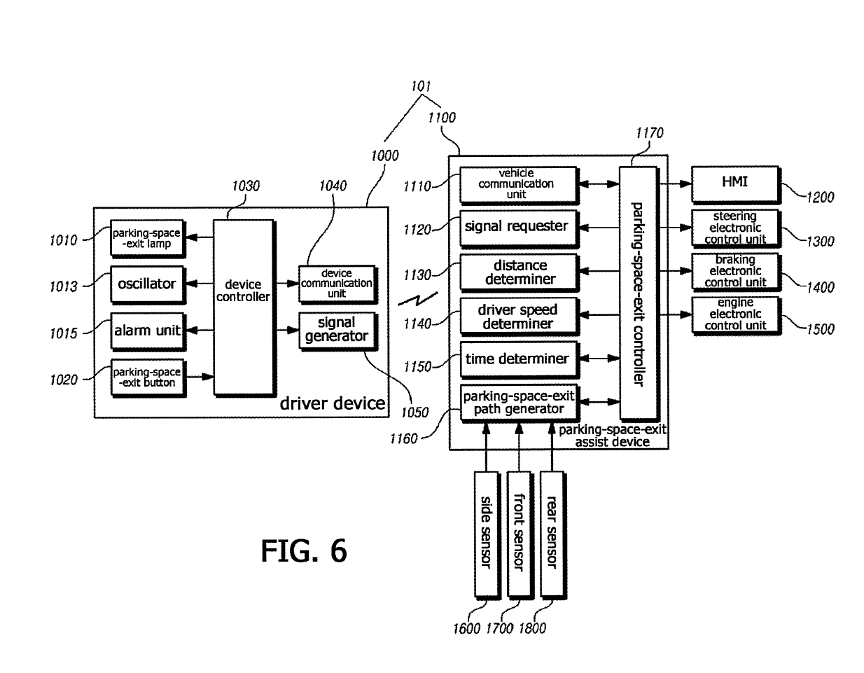

FIG. 5 is a conceptual diagram for describing an operation of a parking-space-exit assist system according to another embodiment of the present invention, and FIG. 6 is a block diagram of the parking-space-exit assist system according to the other embodiment of the present invention.

Referring to FIG. 6, a parking-space-exit assist system 101 according to the other embodiment of the present invention includes a driver device 1000 and a parking-space-exit assist device 1100 like the parking-space-exit assist system 1 of the embodiment in FIG. 2, but the driver device 1000 of the present embodiment is configured with a vehicle smart key in which a display panel is not formed.

The driver device 1000 according to the present embodiment may include a device communication unit 1040 for communication with a vehicle, a parking-space-exit lamp 1010 configured to display that parking-space-exiting is possible, an oscillator 1013, an alarm unit 1015, a parking-space-exit button 1020 for selecting parking-space-exiting, a signal generator 1050 configured to generate a position signal for indicating a position of the driver device 1000, and a device controller 1030 configured to control the driver device 1000 in relation to automatic parking-space-exiting.

The device communication unit 1040 may use various communication methods, such as a RF communication method, capable of remote communication with a vehicle.

The parking-space-exit lamp 1010 may be turned on according to control of the device controller 1030 and flicker or remain turned on. Upon receiving a message, which indicates that parking-space-exiting is possible, from the parking-space-exit assist device 1100 of the vehicle, the device controller 1030 may operate the parking-space-exit lamp 1010.

The oscillator 1013 may operate according to control of the device controller 1030, generate vibration, and allow the driver to recognize that parking-space-exiting is possible. The oscillator 1013 may also be simultaneously operated with the parking-space-exit lamp 1010.

The alarm unit 1015 operates according to control of the device controller 1030 and generates an alarm, thereby allowing the driver to recognize that parking-space-exiting is possible. The alarm unit 1015 may also be simultaneously operated with the parking-space-exit lamp 1010.

The parking-space-exit button 1020 is a button that allows remote parking-space-exiting to be selected by the driver. When the driver selects the parking-space-exit button 1020, the device controller 1030 may transmit a signal, which indicates that the parking-space-exiting function has been selected, to the parking-space-exit assist device 1100.

The signal generator 1050 may generate a position signal for indicating a position of the driver device 1000. The signal generator 1050 may generate the position signal at preset, prescribed time intervals. That is, the signal generator 1050 may intermittently generate the position signal at prescribed time intervals. Upon receiving a position request signal from the parking-space-exit assist device 1100, the device controller 1030 may control the signal generator 1050 to operate.

Upon receiving the position request signal from the parking-space-exit assist device 1100 of the vehicle, the device controller 1030 may turn on the parking-space-exit lamp 1010 while operating the signal generator 1050 and generating the position signal.

Then, when the driver selects the parking-space-exit button 1020, the device controller 1030 may transmit a signal, which indicates that parking-space-exiting has been selected, to the parking-space-exit assist device 1100 via the device communication unit 1040.

Referring back to FIG. 6, the parking-space-exit assist device 1100 according to the other embodiment of the present invention may include a vehicle communication unit 1110, a signal requester 1120, a distance determiner 1130, a driver speed determiner 1140, a time determiner 1150, a parking-space-exit path generator 1160, and a parking-space-exit controller 1170. Such a parking-space-exit assist device 1100 may receive information from a side sensor 1600, a front sensor 1700, and a rear sensor 1800 provided in the vehicle and may generate a control signal for control of a HMI 1200, a steering electronic control unit 1300, a braking electronic control unit 1400, and an engine electronic control unit 1500.

The vehicle communication unit 1110 may perform communication with the device communication unit 1040 and perform communication using the same communication method as the device communication unit 1040.

The signal requester 1120 may generate a position request signal which requests for a position signal for identifying the position of the driver device 1000. The signal requester 1120 may generate a position request signal several times according to control from the parking-space-exit controller 1170.

The distance determiner 1130 may determine a distance between the driver device 1000 and the vehicle and may use a difference between time at which the position request signal is generated in the signal requester 1120 and time at which the position signal is received from the driver device 1000.

The distance determiner 1130 has information on speeds of the position request signal and the position signal. The distance determiner 1130 may determine the distance between the driver device 1000 and the vehicle by using the difference between the time at which the position request signal is transmitted and the time at which the position signal is received and by using the speeds of the position request signal and the position signal.

When the position request signal is repeatedly generated at prescribed time intervals, the distance determiner 1130 may determine the distance between the driver device 1000 and the vehicle several times.

The driver speed determiner 1140 may receive information on the distance between the vehicle and the driver determined in the distance determiner 1130. When the distance is repeatedly determined in the distance determiner 1130, the driver speed determiner 1140 may determine the speed of the driver by using the time interval at which the distance is determined and a change in the distance between the vehicle and the driver.

The time determiner 1150 may determine time at which the driver is expected to arrive at the vehicle by using the speed of the driver determined in the driver speed determiner 1140 and by using the distance between the driver and the vehicle determined in the distance determiner 1130.

As in the embodiment described above with reference to FIG. 2, the parking-space-exit path generator 1160 may receive sensing information from the side sensor 1600, the front sensor 1700, and the rear sensor 1800 and then generate a parking-space-exit path. The parking-space-exit path generator 1160 may generate the parking-space-exit path in the same direction as a direction in which the vehicle has entered the parking space.

In order to detect the driver device 1000 approaching the vehicle within a prescribed distance, the parking-space-exit controller 1170 may operate the signal requester 1120 and control the position request signal to be generated. When the position signal is received from the driver device 1000 in response to the position request signal, the parking-space-exit controller 1170 may operate the distance determiner 1130, the driver speed determiner 1140, and the time determiner 1150 so that the distance between the driver device 1000 and the vehicle and the time at which the driver is expected to arrive at the vehicle are determined.

In this case, the parking-space-exit controller 1170 may control the parking-space-exit path generator 1160 and receive information on whether parking-space-exiting is possible and information on a parking-space-exit path. When parking-space-exiting is possible, the parking-space-exit controller 1170 may transmit a signal, which indicates that parking-space-exiting is possible, to the driver device 1000.

In addition, when parking-space-exiting is possible, the parking-space-exit controller 1170 may display a message, which indicates that automatic parking-space-exiting is possible, via the HMI 1200 in the vehicle and may generate a control signal for control of the steering electronic control unit 1300, the braking electronic control unit 1400, and the engine electronic control unit 1500 so that the vehicle exits the parking space along the parking-space-exit path.

Meanwhile, the driver may set a parking-space-exit direction via the HMI 1200, and when the parking-space-exit direction is set, the parking-space-exit controller 1170 may control a parking-space-exit path to be generated in the parking-space-exit direction selected by the driver in the parking-space-exit path generator 1160.

In addition, the driver may set a parking-space-exit period via the HMI 1200, and when the parking-space-exit period is set, the parking-space-exit controller 1170 may generate a control signal for control of the steering electronic control unit 1300, the braking electronic control unit 1400, and the engine electronic control unit 1500 so that the vehicle starts to exit the parking space when the parking-space-exit period comes.

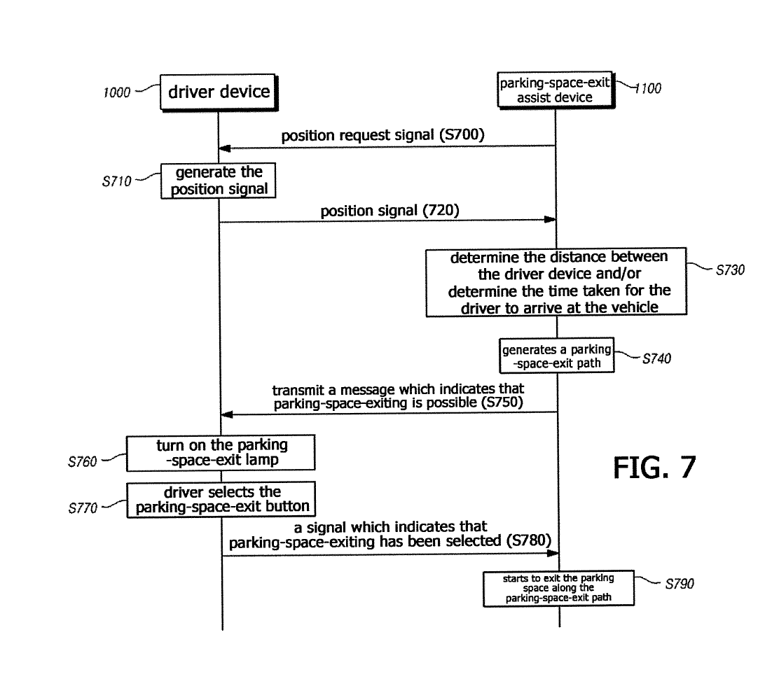

A process in which remote parking-space-exiting is performed in the parking-space-exit assist system 101 according to the other embodiment of the present invention according to the above configuration will be described below with reference to FIG. 7.

Referring to the drawing, the parking-space-exit controller 1170 of the parking-space-exit assist device 1100 according to the other embodiment of the present invention may control the signal requester 1120 so that the position request signal is transmitted to the driver device 1000 at every prescribed time (S700).

Upon receiving the position request signal, the device controller 1030 of the driver device 1000 may control the signal generator 1050 to generate the position signal (S710) and may transmit the generated position signal to the parking-space-exit assist device 1100 (S720).

In the distance determiner 1130, the driver speed determiner 1140, and the time determiner 1150 of the parking-space-exit assist device 1100, the distance between the driver device 1000 and the vehicle may be determined using a time difference between the position request signal and the position signal and speeds of the position request signal and the position signal, the speed of the driver and/or the time taken for the driver to arrive at the vehicle may be determined on the basis of the determined distance (S730).

The parking-space-exit controller 1170 may determine whether parking-space-exiting is possible when the distance between the driver device 1000 and the vehicle is a prescribed distance or less or the time taken for the driver to arrive at the vehicle is a prescribed amount of time or less, and when parking-space-exiting is possible, the parking-space-exit controller 1170 may control the parking-space-exit path generator 1160 to generate a parking-space-exit path (S740). In this case, the parking-space-exit path generator 1160 may generate a parking-space-exit path in a parking-space-exit direction preset by the driver.

When parking-space-exiting is possible by control of the parking-space-exit controller 1170, the parking-space-exit controller 1170 may transmit a message, which indicates that parking-space-exiting is possible, to the driver device 1000 (S750), and the device controller 1030 of the driver device 1000 may turn on the parking-space-exit lamp 1010, generate vibration, or generate an alarm sound (S760).

When the driver selects the parking-space-exit button 1020 (S770), the device controller 1030 may transmit a signal, which indicates that parking-space-exiting has been selected, to the parking-space-exit assist device 1100 (S780).

The parking-space-exit controller 1170 of the parking-space-exit assist device 1100 may display a message, which indicates that automatic parking-space-exiting will be performed, via the HMI 1200 and may generate a control signal for control of the steering electronic control unit 1300, the braking electronic control unit 1400, and the engine electronic control unit 1500 so that the vehicle starts to exit the parking space along the parking-space-exit path (S790).

Meanwhile, the parking-space-exit controller 1170 may also adjust a parking-space-exit period by using information on a parking-space-exit period set by the driver via the HMI 1200.

In this way, the parking-space-exit assist systems 1 and 101 according to the present invention include the driver devices 10 and 1000 and the parking-space-exit assist devices 100 and 1100 and allow the vehicle to exit the parking space before the driver arrives at the vehicle so that, in addition to having no need for a driver to directly drive a vehicle out of a parking space, the driver may immediately drive the vehicle without the need for waiting for the vehicle to exit the parking space. Accordingly, it is possible to promote convenience of a driver.

The above-mentioned present invention has an advantageous effect in that convenience of a driver can be promoted since, in addition to having no need for a driver to directly drive a vehicle out of a parking space, there is no need for the driver to wait for the vehicle to exit the parking space.

Although the abovementioned exemplary embodiments according to the present invention have been described in detail with reference to the above specific examples, the embodiments are, however, intended to be illustrative only, and thereby do not limit the scope of protection of the present invention. Thereby, it should be appreciated by the skilled in the art that various modifications and exemplary embodiments of equivalent scopes to the above examples may be made without deviating from the scope of protection of the invention. Thus, the true technical scope of protection of the invention must be determined by the following claims.

What is claimed is:

1. A parking-space-exit assist system comprising:
a driver device owned by a driver; and
an assist device provided in a vehicle and configured to cause the vehicle to exit a parking space when it is determined that the driver device is within a prescribed distance from the vehicle or is expected to arrive at the vehicle within a prescribed amount of time.

2. The parking-space-exit assist system of claim 1, wherein the assist device comprises:
a first determiner configured to determine a distance between the driver device and the vehicle; and
a first controller configured to generate a control signal for causing the vehicle to exit the parking space when the distance between the driver device and the vehicle is within the prescribed distance.

3. The parking-space-exit assist system of claim 2, wherein:
the assist device further comprises a first generator configured to generate a parking-space-exit path of the vehicle; and
the first controller generates a control signal so that the vehicle exits the parking space according to the parking-space-exit path generated in the first generator.

4. The parking-space-exit assist system of claim 3, wherein the first generator generates the parking-space-exit path of the vehicle in consideration of a parking-space-exit direction selected by the driver and a parking-space-exit direction.

5. The parking-space-exit assist system of claim 2, wherein:
the assist device further comprises a second determiner configured to determine time taken for the driver device to reach the vehicle; and
the first controller generates a control signal for causing the vehicle to exit the parking space when the distance between the driver device and the vehicle is within the prescribed distance and/or when the time is a prescribed amount of time or less.

6. The parking-space-exit assist system of claim 4, wherein:
the assist device further includes a second generator configured to generate a parking-space-exit path of the vehicle; and
the first controller generates a control signal so that the vehicle exits the parking space according to the parking-space-exit path generated in the second generator.

7. The parking-space-exit assist system of claim 6, wherein the second generator generates the parking-space-exit path of the vehicle in consideration of a parking-space-exit direction selected by the driver and a parking-space-exit direction.

8. The parking-space-exit assist system of claim 2, wherein the driver device comprises:
a display unit;
a second controller configured to control a parking-space-exit application; and
a third controller configured to control operation of the driver device on the basis of a driver's selection received via the parking-space-exit application and information received from the assist device.

9. The parking-space-exit assist system of claim 8, wherein the second controller receives a selection on a parking-space-exit period of the vehicle and a selection on a parking-space-exit direction of the vehicle via the display unit and provides the selections to the third controller.

10. The parking-space-exit assist system of claim 8, wherein:
the driver device further includes a first module configured to receive position information of the driver device; and
the first determiner determines the distance between the driver device and the vehicle by using position information of the vehicle provided from a second module configured to receive the position information of the vehicle and by using the position information of the driver device.

11. The parking-space-exit assist system of claim 2, wherein the driver device comprises:
a button configured to receive a parking-space-exit assist selection from the driver;
an alarm unit configured to notify the driver of the fact that it is possible to cause the vehicle to exit the parking space; and
a fourth controller configured to transmit the driver's parking-space-exit selection information to the assist device when the driver provides a signal to the button.

12. The parking-space-exit assist system of claim 11, wherein:
the assist device further comprises a signal requester configured to generate a position request signal that requests for the position information of the driver device;
the driver device further comprises a signal generator configured to generate a position signal related to the position request signal; and
the first determiner determines the distance between the driver device and the vehicle by using speeds of the position request signal and the position signal and a time difference between time at which the position request signal is transmitted and time at which the position signal is received.
